(19) United States
(12) Patent Application Publication
(10) Pub. No.: US 2014/0274111 A1
(43) Pub. Date: Sep. 18, 2014

(54) INTER-DEVICE TRANSFER OF ACCURATE LOCATION INFORMATION

(71) Applicant: QUALCOMM INCORPORATED, San Diego, CA (US)

(72) Inventors: Stephen William Edge, Escondido, CA (US); Marc Anthony Ische, San Diego, CA (US)

(73) Assignee: Qualcomm Incorporated, San Diego, CA (US)

(21) Appl. No.: 13/827,024

(22) Filed: Mar. 14, 2013

(51) Int. Cl. H04W 4/02

(52) U.S. Cl. CPC H04W 4/023
USPC 455/456.1

(57) ABSTRACT

The disclosure is directed to determining a location of a user equipment (UE) in a poor positioning environment based on locations of one or more devices. A first location and a first location uncertainty of the first device is received from a first device, a determination whether or not the first location uncertainty is less than a location uncertainty of the UE is made, and if the first location uncertainty is less than the location uncertainty of the UE, the location of the UE is determined based on the location of the first device and a distance to the first device.

### BACKGROUND OF THE INVENTION

1. Field of the Invention

Aspects of the disclosure are directed to transfer of accurate location information between mobile devices.

2. Description of the Related Art

Modern user devices, such as cell phones, smart phones, tablet computers, personal digital assistants (PDAs), and the like, are typically able to accurately determine their location based on signals received from one or more radio transmitters using some form of multilateration or trilateration. The transmitters can be satellites in a global navigation satellite system (GNSS), such as the global positioning system (GPS), or terrestrial radio frequency (RF) transmitters, such as cellular base stations, local wireless network access points, and the like. Local wireless network access points can include wireless local area network (WLAN) access points, WiFi access points, femto cells, Bluetooth® transmitters, near field communication transmitters, and the like.

Maintaining an accurate location inside a building or other enclosed structure, such as a subway system, can be challenging in the absence of local wireless network access points that have previously been accurately positioned using, for example, crowd sourcing. In such an environment, it may be impossible to use a GNSS or assisted GNSS (A-GNSS) due to excessive attenuation of the satellite signals. Positioning using signals from outdoor macro cells may be just as difficult due to very limited building penetration. While inertial navigation (using internal sensors such as accelerometers, magnetometers, gyroscopes, etc.) can be used to accurately track location when the user device first enters the enclosed structure by updating the last accurate location estimate obtained outside of the structure, the gradual accumulation of small errors in sensor measurements eventually renders any location estimate too inaccurate for many uses.

### SUMMARY

Aspects of the disclosure are directed to determining a location of a user equipment (UE) in a poor positioning environment based on locations of one or more devices. A method for determining a location of a UE in a poor positioning environment based on locations of one or more devices includes receiving, from a first device, a first location and a first location uncertainty of the first device, determining whether or not the first location uncertainty is less than a location uncertainty of the UE, and if the first location uncertainty is less than the location uncertainty of the UE, determining the location of the UE based on the location of the first device and a distance to the first device.

An apparatus for determining a location of a UE in a poor positioning environment based on locations of one or more devices includes logic configured to receive, from a first device, a first location and a first location uncertainty of the first device, logic configured to determine whether or not the first location uncertainty is less than a location uncertainty of the UE, and logic configured to determine the location of the UE based on the location of the first device and a distance to the first device if the first location uncertainty is less than the location uncertainty of the UE.

An apparatus for determining a location of a UE in a poor positioning environment based on locations of one or more devices includes means for receiving, from a first device, a first location and a first location uncertainty of the first device, means for determining whether or not the first location uncertainty is less than a location uncertainty of the UE, and means for determining the location of the UE based on the location of the first device and a distance to the first device if the first location uncertainty is less than the location uncertainty of the UE.

A non-transitory computer-readable medium for determining a location of a UE in a poor positioning environment based on locations of one or more devices includes at least one instruction to receive, from a first device, a first location and a first location uncertainty of the first device, at least one instruction to determine whether or not the first location uncertainty is less than a location uncertainty of the UE, and at least one instruction to determine the location of the UE based on the location of the first device and a distance to the first device if the first location uncertainty is less than the location uncertainty of the UE.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates a high-level system architecture of a wireless communications system in accordance with an aspect of the disclosure.

FIG. 2 illustrates examples of user equipments (UEs) in accordance with aspects of the disclosure.

FIG. 3 illustrates a communication device that includes logic configured to perform functionality in accordance with an aspect of the disclosure.

FIG. 4 illustrates an exemplary server according to various aspects of the disclosure.

FIG. 5 illustrates a good positioning environment and a poor positioning environment.

FIG. 6 illustrates an exemplary flow determining a location of a UE in a poor positioning environment based on the locations of one or more other UEs.

### DETAILED DESCRIPTION

Various aspects are disclosed in the following description and related drawings. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

A client device, referred to herein as a user equipment (UE), may be mobile or stationary, and may communicate with a radio access network (RAN). As used herein, the term “UE” may be referred to interchangeably as an “access terminal” or “AT,” a “wireless device,” a “subscriber device,” a “subscriber terminal,” a “subscriber station,” a “user terminal” or UT, a “mobile terminal,” a “mobile station” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to PC cards, compact flash devices, external or internal modems, wireless or wireline phones, cellular phones, smart phones, tablet computers, laptops, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

FIG. 1 illustrates a high-level system architecture of a wireless communications system 100 in accordance with an aspect of the disclosure. The wireless communications system 100 contains UEs 1 to 4. The UEs 1 to 4 can include cellular telephones, smart phones, tablet computers, personal digital assistant (PDAs), pagers, laptop computers, desktop computers, and the like. For example, in FIG. 1, UE 1 is illustrated as a cellular phone, UEs 2 and 3 are illustrated as smart phones, and UE 4 is illustrated as a desktop computer.

Referring to FIG. 1, UEs 1 to 4 are configured to communicate with an access network (e.g., a RAN 120, an access point 125, etc.) over a physical communications interface or layer, shown in FIG. 1 as air interfaces 104, 106, and/or a direct wired connection. The air interface 104 can comply with a given cellular communications protocol (e.g., Code Division Multiple Access (CDMA), Evolution-Data Optimized (EV-DO), Evolved High Rate Packet Data (eHRPD), Global System of Mobile Communication (GSM), Enhanced Data rates for GSM Evolution (EDGE), Wideband CDMA (WCDMA), Long-Term Evolution (LTE), etc.), while the air interface 106 can comply with a Wireless Local Area Network (WLAN) protocol (e.g., IEEE 802.11). GSM, EDGE, WCDMA and LTE are radio technologies defined by an organization known as the 3^{rd} Generation Partnership Project (3GPP). CDMA, EV-DO and eHRPD are radio technologies defined by an organization known as the 3^{rd} Generation Partnership Project 2 (3GPP2). The RAN 120 includes a plurality of access points that serve UEs over air interfaces, such as the air interface 104. The RAN 120 may be a Universal Mobile Telecommunications System (UMTS) RAN, an LTE RAN, or the like. The access points in the RAN 120 can be referred to as access nodes or ANs, access points or APs, base stations or BSs, Node Bs, eNode Bs, and so on. These access points can be terrestrial access points (or ground stations), or satellite access points, such as satellite 130. The RAN 120 is configured to connect (by either wireless or wireline means) to a core network 140 that can perform a variety of functions, including connecting circuit switched (CS) and packet switched (PS) calls and sessions between UEs served by the RAN 120 and other UEs served by the RAN 120 or a different RAN, or a different network altogether, and can also mediate an exchange of packet-switched (PS) data with external networks such as the Internet 175. The Internet 175 includes a number of routing agents and processing agents (not shown in FIG. 1 for the sake of convenience). In FIG. 1, UE 4 is shown as connecting to the Internet 175 directly (i.e., separate from the core network 140, such as over an Ethernet connection or WiFi or 802.11-based network). The Internet 175 can thereby function to route packet-switched data communications between UE 4 and UEs 1 to 3 via the core network 140. Also shown in FIG. 1 is the access point 125 that is separate from the RAN 120. The access point 125 may be connected to the Internet 175 independent of the core network 140 (e.g., via an optical communication system such as FiOS, a cable modem, etc.). The air interface 106 may serve UE 2 or UE 3 over a local wireless connection, such as IEEE 802.11 in an example. UE 4 is shown as a desktop computer with a wired connection to the Internet 175, such as a direct connection to a modem or router. In an example, UE 4 may connect to Internet 175 via access point 125 (e.g., for a WiFi router with both wired and wireless connectivity).

Referring to FIG. 1, a location server 170 is shown as connected to the Internet 175, the core network 140, or both. The location server 170 can be implemented as a plurality of structurally separate servers, or alternately may correspond to a single server.

UEs 1 to 3 can measure radio signals received from one or more satellites 130, RAN 120, and/or access point 125 and one or more other similar access points to determine their positions. The radio signals being measured may be intended primarily to support communication among UEs or may be intended primarily to support positioning of UEs, or may serve both purposes. In the example of FIG. 1, UE 1 may determine its position based on radio signals received from satellite(s) 130 and/or RAN 120, UE 2 may determine its position based on radio signals received from satellite(s) 130, RAN 120, and/or access point 125, and UE 3 may determine its position based on signals received from satellite(s) 130 and/or access point 125. Such position determination may make use of existing position methods such as standalone GNSS, Assisted GNSS (A-GNSS), advanced forward link trilateration (AFLT), observed time difference of arrival (OTDOA), Enhanced Cell ID (E-CID), WiFi-based positioning, or the like. These positioning methods may be supported by UEs 1, 2 and 3 making measurements (e.g. measurements of signal timing, signal direction and/or signal strength) of received radio signals (e.g. from RAN 120, access point 125, and/or satellite(s) 130) and computing a position estimate from these measurements. In some aspects, assistance data may be provided by a network (e.g. RAN 120, core network 140) or a location server (e.g. location server 170) to UEs to assist measurement of radio signals (e.g. enable faster and more accurate acquisition of radio signals). In some aspects, a network (e.g. RAN 120, core network 140) or a location server (e.g. location server 170) may compute a location estimate for a UE (e.g. UE 1 or UE 2) based on radio signal measurements transferred from the UE to the network or location server and may return the computed location estimate to the UE.

The wireless communications system 100 is an example of a “good” positioning environment, or just a “good environment,” because a UE can accurately determine its position from satellite, cellular, and/or local wireless network positioning systems as described above. A good environment is typically an outdoors environment, where the UE can receive positioning signals with little or no attenuation.

Note that in this disclosure, the terms “position” and “location” are used interchangeably, and can refer to an absolute geographic position or a position relative to other points.

FIG. 2 illustrates examples of UEs in accordance with aspects of the disclosure. Referring to FIG. 2, UE 200A is illustrated as a cellular telephone and UE 200B is illustrated as a touchscreen device (e.g., a smart phone, a tablet computer, etc.). As shown in FIG. 2, an external casing of UE 200A is configured with an antenna 205A, display 210A, at least one button 215A (e.g., a PTT button, a power button, a volume control button, etc.) and a keypad 220A among other components, as is known in the art. Also, an external casing of UE 200B is configured with a touchscreen display 205B, peripheral buttons 210B, 215B, 220B and 225B (e.g., a power control button, a volume or vibrate control button, an airplane mode toggle button, etc.), at least one front-panel button 230B (e.g., a Home button, etc.), among other components, as is known in the art. While not shown explicitly as part of UE 200B, the UE 200B can include one or more external antennas and/or one or more integrated antennas that are built into the external casing of UE 200B, including but not limited to WiFi antennas, cellular antennas, satellite position system (SPS) antennas (e.g., global positioning system (GPS) antennas), and so on.

While internal components of UEs such as the UEs 200A and 200B can be embodied with different hardware configurations, a basic high-level UE configuration for internal hardware components is shown as platform 202 in FIG. 2. The platform 202 can receive and execute software applications, data and/or commands transmitted from the RAN 120 that may ultimately come from the core network 140, the Internet 175 and/or other remote servers and networks (e.g., location server 170, web URLs, etc.). The platform 202 can also independently execute locally stored applications without RAN interaction. The platform 202 can include internal sensors 204, such as accelerometers, magnetometers, gyroscopes, barometers, thermometers etc., that can be used for inertial navigation. For example, accelerometers may be used to measure linear acceleration and velocity, magnetometers may be used to measure direction and orientation, gyroscopes may be used to measure angular motion and direction and barometers and/or thermometers may be used to measure changes in altitude and environment. The platform 202 can further include a transceiver 206 operably coupled to an application specific integrated circuit (ASIC) 208, or other processor, microprocessor, logic circuit, or other data processing device. The ASIC 208 or other processor executes the application programming interface (API) 210 layer that interfaces with any resident programs or applications in the memory 212 of the wireless device. The memory 212 can be comprised of read-only memory (ROM) or random-access memory (RAM), electrically erasable programmable ROM (EEPROM), flash cards, or any memory common to computer platforms. The platform 202 also can include a local database 214 that can store applications not actively used in memory 212, as well as other data. The local database 214 is typically a flash memory cell, but can be any secondary storage device as known in the art, such as magnetic media, EEPROM, optical media, tape, soft or hard disk, or the like.

Accordingly, an aspect of the disclosure can include a UE (e.g., UE 200A, 200B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the UEs 200A and 200B in FIG. 2 are to be considered merely illustrative and the disclosure is not limited to the illustrated features or arrangement.

The wireless communication between the UEs 200A and/or 200B and the RAN 120 can be based on different technologies, such as CDMA, WCDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs from the RAN using a variety of networks and configurations. Accordingly, the illustrations provided herein are not intended to limit the aspects of the disclosure and are merely to aid in the description of various aspects of the disclosure.

FIG. 3 illustrates a communication device 300 that includes logic configured to perform functionality. The communication device 300 can correspond to any of the above-noted communication devices, including but not limited to UEs 200A or 200B, any component of the RAN 120, any component of the core network 140, any components coupled with the core network 140 and/or the Internet 175 (e.g., the location server 170), and so on. Thus, communication device 300 can correspond to any electronic device that is configured to communicate with (or facilitate communication with) one or more other entities over the wireless communications system 100 of FIG. 1.

Referring to FIG. 3, the communication device 300 includes logic configured to receive and/or transmit information 305. In an example, if the communication device 300 corresponds to a wireless communications device (e.g., UE 200A or 200B), the logic configured to receive and/or transmit information 305 can include a wireless communications interface (e.g., Bluetooth, WiFi, 2G, CDMA, WCDMA, 3G, 4G, LTE, etc.) such as a wireless transceiver and associated hardware (e.g., an RF antenna, a MODEM, a modulator and/or demodulator, etc.). In another example, the logic configured to receive and/or transmit information 305 can correspond to a wired communications interface (e.g., a serial connection, a USB or Firewire connection, an Ethernet connection through which the Internet 175 can be accessed, etc.). Thus, if the communication device 300 corresponds to some type of network-based server (e.g., the location server 170), the logic configured to receive and/or transmit information 305 can correspond to an Ethernet card, in an example, that connects the network-based server to other communication entities via an Ethernet protocol. In a further example, the logic configured to receive and/or transmit information 305 can include sensory or measurement hardware by which the communication device 300 can monitor its local environment (e.g., an accelerometer, a temperature sensor, a light sensor, an antenna for monitoring local RF signals, etc.). The logic configured to receive and/or transmit information 305 can also include logic configured to receive, from a first device, a first location and a first location uncertainty of the first device. The logic configured to receive and/or transmit information 305 can also include software that, when executed, permits the associated hardware of the logic configured to receive and/or transmit information 305 to perform its reception and/or transmission function(s). However, the logic configured to receive and/or transmit information 305 does not correspond to software alone, and the logic configured to receive and/or transmit information 305 relies at least in part upon hardware to achieve its functionality.

Referring to FIG. 3, the communication device 300 further includes logic configured to process information 310. In an example, the logic configured to process information 310 can include at least a processor. Example implementations of the type of processing that can be performed by the logic configured to process information 310 includes but is not limited to performing determinations, establishing connections, making selections between different information options, performing evaluations related to data, interacting with sensors coupled to the communication device 300 to perform measurement operations, converting information from one format to another (e.g., between different protocols such as .wmv to .avi, etc.), and so on. For example, the logic configured to process information 310 can include logic configured to determine whether or not the first location uncertainty is less than a location uncertainty of the communication device 300 and logic configured to determine the location of the communication device 300 based on the location of the first device and a distance to the first device if the first location uncertainty is less than the location uncertainty of the communication device 300. The processor included in the logic configured to process information 310 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 310 can also include software or firmware that, when executed, permits the associated hardware of the logic configured to process information 310 to perform its processing function(s). However, the logic configured to process information 310 does not correspond to software alone, and the logic configured to process information 310 relies at least in part upon hardware to achieve its functionality.

Referring to FIG. 3, the communication device 300 further includes logic configured to store information 315. In an example, the logic configured to store information 315 can include at least a non-transitory memory and associated hardware (e.g., a memory controller, etc.). For example, the non-transitory memory included in the logic configured to store information 315 can correspond to RAM, flash memory, ROM, erasable programmable ROM (EPROM), EEPROM, registers, hard disk, a removable disk, a CD-ROM, or any other form of storage medium known in the art. The logic configured to store information 315 can also include software or firmware that, when executed, permits the associated hardware of the logic configured to store information 315 to perform its storage function(s). However, the logic configured to store information 315 does not correspond to software alone, and the logic configured to store information 315 relies at least in part upon hardware to achieve its functionality.

Referring to FIG. 3, the communication device 300 further optionally includes logic configured to present information 320. In an example, the logic configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted to a user or operator of the communication device 300. For example, if the communication device 300 corresponds to UE 200A or UE 200B as shown in FIG. 2, the logic configured to present information 320 can include the display 210A of UE 200A or the touchscreen display 205B of UE 200B. In a further example, the logic configured to present information 320 can be omitted for certain communication devices, such as network communication devices that do not have a local user (e.g., network switches or routers, remote servers, etc.) or devices that have a user but where interaction with the user is not needed or is not supported (e.g. a wearable or attached device that maintains and provides the location of a child, animal, or valuable asset). The logic configured to present information 320 can also include software that, when executed, permits the associated hardware of the logic configured to present information 320 to perform its presentation function(s). However, the logic configured to present information 320 does not correspond to software alone, and the logic configured to present information 320 relies at least in part upon hardware to achieve its functionality.

Referring to FIG. 3, the communication device 300 further optionally includes logic configured to receive local user input 325. In an example, the logic configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 300. For example, if the communication device 300 corresponds to UE 200A or UE 200B as shown in FIG. 2, the logic configured to receive local user input 325 can include the keypad 220A, any of the buttons 215A or 210B through 225B, the touchscreen display 205B, etc. In a further example, the logic configured to receive local user input 325 can be omitted for certain communication devices, such as network communication devices that do not have a local user (e.g., network switches or routers, remote servers, etc.) or devices that have a user but where interaction with the user is not needed or is not supported (e.g. a wearable or attached device that maintains and provides the location of a child, animal, or valuable asset). The logic configured to receive local user input 325 can also include software that, when executed, permits the associated hardware of the logic configured to receive local user input 325 to perform its input reception function(s). However, the logic configured to receive local user input 325 does not correspond to software alone, and the logic configured to receive local user input 325 relies at least in part upon hardware to achieve its functionality.

Referring to FIG. 3, while the configured logics of 305 through 325 are shown as separate or distinct blocks in FIG. 3, it will be appreciated that the hardware and/or software by which the respective configured logic performs its functionality can overlap in part. For example, any software used to facilitate the functionality of the configured logics of 305 through 325 can be stored in the non-transitory memory associated with the logic configured to store information 315, such that the configured logics of 305 through 325 each performs their functionality (i.e., in this case, software execution) based in part upon the operation of software stored by the logic configured to store information 315. Likewise, hardware that is directly associated with one of the configured logics can be borrowed or used by other configured logics from time to time. For example, the processor of the logic configured to process information 310 can format data into an appropriate format before being transmitted by the logic configured to receive and/or transmit information 305, such that the logic configured to receive and/or transmit information 305 performs its functionality (i.e., in this case, transmission of data) based in part upon the operation of hardware (i.e., the processor) associated with the logic configured to process information 310.

Generally, unless stated otherwise explicitly, the phrase “logic configured to” as used throughout this disclosure is intended to invoke an aspect that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the aspects described below in more detail.

The various aspects may be implemented on any of a variety of commercially available server devices, such as server 400 illustrated in FIG. 4. In an example, the server 400 may correspond to one example configuration of the location server 170 described above. In FIG. 4, the server 400 includes a processor 401 coupled to volatile memory 402 and a large capacity nonvolatile memory, such as a disk drive 403. The server 400 may also include a floppy disc drive, compact disc (CD) or DVD disc drive 406 coupled to the processor 401. The server 400 may also include network access ports 404 coupled to the processor 401 for establishing data connections with a network 407, such as a local area network coupled to other broadcast system computers and servers or to the Internet. In context with FIG. 3, it will be appreciated that the server 400 of FIG. 4 illustrates one example implementation of the communication device 300, whereby the logic configured to transmit and/or receive information 305 corresponds to the network access points 404 used by the server 400 to communicate with the network 407, the logic configured to process information 310 corresponds to the processor 401, and the logic configuration to store information 315 corresponds to any combination of the volatile memory 402, the disk drive 403 and/or the disc drive 406. The optional logic configured to present information 320 and the optional logic configured to receive local user input 325 are not shown explicitly in FIG. 4 and may or may not be included therein. Thus, FIG. 4 helps to demonstrate that the communication device 300 may be implemented as a server, in addition to a UE implementation as in 205A or 205B as in FIG. 2.

A poor positioning environment, or “poor environment,” is one in which a user device cannot typically determine its location from satellite, cellular, and/or local wireless network positioning systems, such as GNSS, A-GNSS, AFLT, OTDOA, E-CID, WiFi or the like. A poor positioning environment will typically be an indoor or underground location, such as a building or subway system, due to excessive attenuation of positioning signals at these types of locations. In a poor environment, radio signals from some sources (e.g. WiFi access points, Femtocells) may sometimes be available, but there may be insufficient such sources to obtain location accurately (e.g. via trilateration). Alternatively, there may be some radio sources but the locations of the radio sources may not be known (e.g. due to lack of a site survey or lack of site measurements), or the locations of the radio sources may be known but may be unavailable to the user device or any location server in communication with the user device. Thus, not every indoor or underground location may constitute a poor positioning environment (e.g. in the case that radio signals can be detected at the location from multiple radio sources having locations that are both known and available). However, there may still be many indoor and/or underground locations for which location cannot be supported and that are thus poor positioning environments.

When a user device enters a poor positioning environment, it may still have an accurate estimate of its location that was obtained using, for example, standalone GNSS, A-GNSS, AFLT, OTDOA, E-CID, WiFi, or the like, while it was still outside of the poor environment. Alternatively, the user device may obtain its location via near-field communication (NFC) or Bluetooth (BT) interaction with some fixed device, such as a subway system billing machine, whose location is known and has been configured. Since NFC and BT communication often occur over very short distances (e.g. a few centimeters for NFC), the known location of the fixed device when transmitted to a user device may become a highly accurate location for the user device. After losing reception of reliable positioning signals, the user device may be able to maintain its location in the poor positioning environment for a temporary period of time (e.g. 10 minutes) using inertial navigation based on sensor measurements internal to the user device. However, the accuracy of the user device location will typically degrade as small measurement errors from internal sensors accumulate over time. Eventually, the user device location may become too inaccurate to support many applications, for example, the provision of navigation directions to the user or the provision to the user of the location of nearby places (e.g. restaurant, ticket kiosk, exit door, etc.).

To address this issue, the user device can broadcast its current location to other user devices using direct peer-to-peer radio communications, such as LTE-Direct (LTE-D), WiFi-Direct (WiFi-D), and/or the like. The other user devices that receive the location broadcasts can compute a round trip time (RTT) to the broadcasting user device. The RTT may be a significant parameter in deciding whether another user device is in proximity or not and can be measured via signal timing or from signal strength and signal quality. The receiving devices can then update their own locations using the location broadcasts and RTTs from two or more other user devices. Alternatively, the location broadcast and RTT for just one broadcasting device may be enough to update another user device's location when the transmission distance is known to be small due, for example, to receipt of a strong signal or measurement of a small RTT.

In this way, user devices whose own location estimates have degraded due to being inside a poor positioning environment for a long period of time can update their locations using location broadcasts from user devices that have recently entered the enclosed structure and that thus typically have more accurate location estimates. User devices can maintain an uncertainty factor (i.e. probable error) in their own location estimates and include this with the locations they broadcast. This can allow user devices to selectively use only the more accurate locations of other user devices, such as those that have most recently entered the poor environment. In a subway system, for example, user devices may travel long distances from one station to another during which time their own internal location may degrade significantly. However, these devices may be able to refresh their locations from user devices that have just entered the system, e.g. devices associated with users who have just boarded a train.

Maintenance of accurate locations in this way can also be used to help crowd source the locations of, for example, local wireless network access points and/or NFC and BT devices inside the poor positioning environment. For example, user devices may record the identity (e.g. an IEEE Media Access Control (MAC) address in the case of a WiFi access point) of each access point (or BT or NFC device) detected while in the poor location environment together with the current user device's estimate of its own location and location uncertainty at or during the time the access point was detected. The user device may also make and record signal measurements associated with the detected access point, such as measurements of radio signal strength from the access point and/or RTT. At some later time, the user device may upload the stored data for all access points detected while in the poor environment to a server, such as location server 170 in FIG. 1. The server may then combine the information received from many user devices to estimate the locations of the access points.

To detect and correct location errors (e.g. location errors relating to user devices and/or fixed access points), user devices can compare location information they receive from multiple other devices and filter out locations that are inconsistent with those from most other devices. This can be done on an ongoing basis. In one example, a user device that broadcasts an erroneous location due, for example, to entering a poor positioning environment with an erroneous location, or acquiring an erroneous location from some other user devices while in the poor positioning environment, may be prevented from impairing the location estimates of another user device if the other user device receives other location estimates from many other user devices and ignores the location estimate from the user device with the erroneous location estimate due to its inconsistency with the location estimates from the many other devices. In another example, an error in the configured location of a given NFC or BT device may temporarily induce location errors in many other user devices (e.g. user devices that receive and make use of the configured erroneous location immediately prior to entering the poor positioning environment) and thereby infect such user devices with erroneous locations. However, such an erroneous location may be detected and removed later when any such infected user device comes into contact with user devices whose locations were correctly provided earlier from other NFC or BT devices or from other reliable position method sources such as A-GNSS, AFLT or OTDOA. Provided the number of infected user devices is much smaller than the total number of user devices in the poor positioning environment, the infected devices may discover the inconsistency between their own erroneous location estimates and the correct location estimates obtained via location broadcast from the much larger number of uninfected user devices. Further, by crowd sourcing locations, NFC or BT devices (or local wireless network access points, for example) that transfer erroneous locations to user devices may be identified and user devices may be instructed (e.g. by a server such as location server 170) to ignore locations from these transmitters.

As an example of location error detection, each user device may maintain a record of the identity of any NFC, BT, or other device from which it obtained a location estimate and may also record whether this location estimate (or a location estimate derived from such a location estimate using inertial sensors) was subsequently found to be inconsistent with either the location estimates of many other user devices or a location estimate obtained by the user device when it next enters a good positioning environment. The user device, or any server to which the location record is later uploaded by the user device, may then determine the NFC, BT, or other device that is in error. Erroneous transmitters may thus be identified by maintaining a history of location updating, detecting when a location is significantly in error (e.g. when a discrepancy occurs with other devices) and backtracking the error to its original source.

In some aspects, user devices may not have to determine which NFC or BT device (or local wireless network access point, for example) is in error, but may simply provide the information (location discrepancy and location updating history) to a server, such as location server 170, which may isolate the error by statistical means using data received from many user devices. For example, infected user devices may transfer an erroneous location to other user devices before discovering their locations were erroneous and the other user devices may transfer their obtained erroneous locations to still further user devices. In some cases, inconsistency with a correct location may not be discovered until a user device reenters a good positioning environment. But a user device may maintain a record of its location history including (i) the determination of a new location using location estimates broadcast from fixed NFC, BT, and/or WiFi devices, for example, and from other mobile user devices, (ii) the detection of a discrepancy in a current location estimate with that obtained from either the received locations of many other user devices or a reliable source of location, such as standalone GNSS, A-GNSS, or OTDOA, and optionally, (iii) the times at which location or a location discrepancy is determined. The user device may also record the value of any newly determined location and its uncertainty together with the value of the previous location and uncertainty for the user device that are being replaced. A user device may then provide such a detailed location history to a central server (e.g. location server 170). The central server may then trace back the location history of each infected user device that has detected a location discrepancy to the source of location prior to entry to the poor positioning environment. Sources of location that are fixed NFC, BT, or WiFi devices, for example, may be considered as candidates for an initial erroneous location. The server may also trace back the location histories of uninfected user devices for which no location discrepancy was detected. Location sources that lead to many infected user devices and few or no uninfected user devices would be prime candidates for erroneous location. Such sources may then be investigated (e.g. via manually locating them or locating them automatically using crowd sourcing) and, if needed, reconfigured with a correct location.

In some aspects, a central server may only trace back the location history of a user device when a location discrepancy is detected the first time the user device updates its location after entering the poor environment using locations received from other devices or using existing position methods if the device has reentered a good environment. This may avoid wrongly attributing an erroneous location to a source of location in a good environment when a user device starts out with a good location estimate in a poor environment and is subsequently infected with an erroneous location from other infected user devices that is not initially detected by the user device due to excessive degradation of the user device's initial location in the poor environment.

FIG. 5 illustrates a good positioning environment 530 and a poor positioning environment 540. The good environment 530 may be an outdoor environment in which UEs 532, 534, and 536 can accurately determine their positions based on signals received from one or more satellites 512 and access points 522 and 524, illustrated as dotted arrows in FIG. 5. Satellite(s) 512 may be one or more GNSS satellites. Access points 522 and 524 may be one or more cellular base stations or local wireless network access points in a cellular or local wireless network positioning system, and may enable locations of UEs 532, 534 and 536 using position methods such as AFLT, OTDOA, E-CID, WiFi, or the like.

The poor environment 540 may be an indoor or underground environment, such as a subway system, in which UEs, such as UEs 542, 544, and 546, cannot reliably receive signals from a satellite, cellular, or local wireless network positioning system, and thus cannot use such a system to determine their locations. The UEs 542, 544, and 546 can, however, communicate with each other via direct peer-to-peer radio communications, such as LTE-D, WiFi-D, and/or the like, as indicated by the bidirectional arrows in FIG. 5. The UEs 542, 544, and 546 may have been in the poor environment for varying periods of time and have travelled varying distances within the poor environment. In certain situations, the UEs may need to obtain permission or authorization from a remote server, such as the location server 170, or from a serving network such as RAN 120 or core network 140, to engage in direct peer-to-peer radio communications. In that case, the UEs may need to obtain this authorization at some point before entering the poor environment.

In the example of FIG. 5, a UE 550 is illustrated as initially in the good environment 530 and about to enter the poor environment 540. Although not shown, UE 550 may determine its position based on signals received from a satellite, cellular, or local wireless network positioning system. Alternatively or additionally, as the UE 550 enters the poor environment 540, it can receive a positioning signal from an access point 526, which may be, for example, an NFC or BT device or the like. The UE 550 may come in very close proximity to (e.g. within a few inches or a few feet) of the access point 526 as is enters the poor environment 540. For example, if the poor environment is a subway system, then the access point 526 may be a subway system billing or ticket or entry machine with a known location that the UE 550 must swipe to gain entrance to the subway system. The access point 526 sends its location to the UE 550, which adopts that location as its own due to the close proximity. In this way, the UE 550 has an accurate position determination upon entering the poor environment, whether or not it knows its position based on a satellite, cellular, or local wireless network positioning system.

Upon entering the poor environment 540, the UE 550 begins tracking its location using inertial navigation. The UE 550 also begins broadcasting its location to other UEs using direct peer-to-peer radio communications. The UE 550 can also broadcast a level of uncertainty, or probable error, in its location. The longer the UE 550 determines its location based on inertial navigation, the higher the uncertainty level of its location. The further the UE 550 travels in the poor environment 540, the higher the uncertainty level of its location may become due to the accumulation of location change errors from inertial sensor measurements. UEs that receive location information (location and uncertainty level) from several other UEs can use this information to update their own position, as discussed with reference to FIG. 6. Once the uncertainty level in its current location rises above a threshold, the UE may temporarily stop updating its location using inertial navigation and may instead update its location based on location information received from other UEs while in the poor environment. Once UE 550 has updated its location based on location information received from others UEs, UE 550 may revert back to updating its location using internal inertial navigation sensors. After some further period of time in which UE 550's location has again degraded, UE 550 may again update its location based on location information received from other UEs. UE 550 may also broadcast its own location and location uncertainty to other UEs which may use this to update their own locations. For example, when UE 550 has just entered the poor environment 540 and while its location is still accurate, other UEs may update their locations based on UE 550's accurate location. For example in a subway train system, UEs that have recently entered the system (e.g. whose users have just entered a station or platform or boarded a train) may provide accurate locations to other UEs that have been in the system for a longer time. As new UEs may be continually entering the system at multiple locations, UEs that have been in the subway system for a long time may be able to update their locations frequently and thereby maintain an accurate location.

In the example of FIG. 5, UEs 544 and 546 receive the location information broadcasted by UE 550, as these UEs are within direct peer-to-peer radio communication range of UE 550. Likewise, UEs 550, 542, and 546 receive the location information broadcasted by UE 544, UEs 550, 542, and 544 receive the location information broadcasted by UE 546, and UEs 544 and 546 receive the location information broadcasted by UE 542.

FIG. 6 illustrates an exemplary flow determining a location of a UE in a poor positioning environment based on the locations of one or more other UEs. At 605, the UE determines whether or not it is in a poor positioning environment. In one aspect, this may be accomplished by determining whether the UE can receive radio signals from one or more GNSS satellites and/or one or more terrestrial base stations and/or access points. If the UE cannot receive such radio signals, or if the UE can receive such radio signals but only from GNSS satellites and/or terrestrial base stations and access points that are either insufficient in number or not of a suitable type to enable accurate measurement of location, the UE may determine it is in a poor positioning environment. In another aspect, the UE may equate being in a poor positioning environment with being out of network coverage, for example, not being able to communicate with RAN 120 or access point 125 in FIG. 1. If the UE is in a poor positioning environment, then at 610, the UE maintains its location using internal inertial sensors, such as accelerometers, magnetometers, gyroscopes, and/or the like. At 615, the UE transmits its location and the corresponding uncertainty level to one or more other UEs via direct peer-to-peer radio communications. Location uncertainty refers to the probable or possible error in the UE's location determination. A UE may determine its location to be within a certain geographic area (e.g. a circle, ellipse or polygon of known size and position). Location uncertainty may then be expressed by the size of the geographic area (e.g. the radius of a circle or the lengths of the semi major axis and semi minor axis of an ellipse) and the probability or confidence that the UE is actually within this area. The smaller the geographic area for a given confidence is, the higher the accuracy of the location determination and the smaller the location uncertainty become. The longer a UE determines its position using inertial navigation only, the larger the geographic area representing its location becomes, and thus, the lower the accuracy of the location determination and the greater the location uncertainty also become.

In some aspects, a UE may broadcast its location and possibly its location uncertainty and other information (e.g. identification of services in which the UE wishes to engage) in order to discover other UEs that are nearby and that have a common interest in supporting services that are related to the UEs being near to one another. For example, when it is possible to maintain accurate location (e.g. the UE is not in a poor positioning environment), a UE A receiving such a broadcast from another UE B may determine if the other UE B is nearby by comparing the location broadcast by the other UE B with the known location of UE A. If UEs A and B are near each other, then one or more applications in one or both UEs that support services related to the UEs being nearby may be informed. The services that are being supported by these applications may be referred to as “proximity services” and may include services that notify a user when friends, relatives or co-workers are nearby or notify a user when the user is near to some place of interest (e.g. a particular shop, an information kiosk, a theatre, a gas station, etc.). In these aspects, the primary reason for a UE to broadcast its location and location uncertainty may be to support such proximity services (e.g. if the broadcast of location has been standardized by such organizations as 3GPP and 3GPP2 to support this). The ability to also support accurate location in a poor positioning environment may then become an additional benefit that requires only limited implementation support in a user device additional to that which is required anyway to broadcast location to and receive location from other UEs to support proximity services.

At 620, the UE receives locations and corresponding uncertainty levels from one or more other UEs (or devices) via direct peer-to-peer radio communications. At 625, the UE determines whether or not its uncertainty level is greater than the uncertainty levels of any of the one or more other devices. If the UE's uncertainty level is less than or equal to the uncertainty levels of each of the other devices, then the flow returns to 605. If, however, the UE's uncertainty level is greater than the uncertainty level of at least one other UE by some threshold (which in some aspects may be zero), then at 630, the UE determines the distance(s) to the UE(s) with lower uncertainty levels. The UE can determine the distance to another UE by calculating the RTT to the other UE. The RTT can be measured via signal timing or from signal strength and signal quality. For example, the RTT may be measured by sending a signal or message from a device A to another device B and receiving back a response that includes the internal delay in the device B in sending back the response. The RTT would then be given by the difference between the transmission and reception times at the device A less the internal response delay at device B. The RTT multiplied by the speed of radio signals (typically the speed of light) and divided by two provides the distance between the device A and device B.

At 635, the UE determines its location and location uncertainty based on the received locations, received location uncertainties, and determined distances using, as an example, some form of trilateration or multilateration. In an aspect, the UE may ignore the determined distances if they are small (e.g. less than some threshold) and/or cannot be determined. In this aspect, the UE may determine its location based on just the received locations from the other devices by, for example, averaging the locations or location coordinates of the other devices or by using a weighted average of the other locations or location coordinates (e.g. where the weighting factors for the locations or location coordinates are proportional to the received signal strength for the associated devices). In this aspect, when the UE receives just one location from one other device and the RTT or distance is determined to be small (e.g. is determined to be less than some threshold) or is assumed to be small (e.g. based on a signal strength from the other device exceeding some threshold), the UE may set its new location to be the same as the location received from the other device and may set its new location uncertainty to be greater than the location uncertainty received from the other device to take account of the error in neglecting the RTT.

At 640, the UE determines whether or not the new location is more accurate than the previous location. If it is not, then the flow returns to 605. If it is, however, then at 645, the UE stores the new location in its internal memory, such as memory 212 or database 214. The flow then returns to 605.

At 605, if the UE is not in a poor positioning environment, then at 650, the UE sends any history of received locations and determined locations that the UE may have stored while previously in a poor positioning environment, to a location server, such as location server 170. The server can use this information to track the location of the UE and to identify and correct errors in the locations of any fixed devices, such as NFC or BT transmitters. The action at 605 may be skipped if the UE has no location history from a poor positioning environment that was not yet sent to a location server. At 655, since the UE is not in a poor environment, it can now determine and maintain its location in the good environment using a satellite, cellular, or local wireless network positioning system. The flow returns to 605 to determine whether or not the UE has entered another poor environment.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method for determining a location of a user equipment (UE) in a poor positioning environment based on locations of one or more devices, comprising:
receiving, from a first device, a first location and a first location uncertainty of the first device;
determining whether or not the first location uncertainty is less than a location uncertainty of the UE; and
if the first location uncertainty is less than the location uncertainty of the UE, determining the location of the UE based on the location of the first device and a distance to the first device.

2. The method of claim 1, wherein the UE determines it is in a poor positioning environment based on at least one of:
being out of network coverage;
an inability to receive radio signals from one or more Global Navigation Satellite System (GNSS) satellites and/or one or more terrestrial base stations and/or access points; or
an ability to receive radio signals only from GNSS satellites and/or terrestrial base stations and/or access points that are insufficient in number and/or not of a suitable type to enable accurate measurement of location.

3. The method of claim 1, further comprising:
transmitting the location of the UE and the location uncertainty of the UE to one or more other devices.

4. The method of claim 3, wherein the location of the UE and the location uncertainty of the UE are transmitted using direct peer-to-peer radio communications.

5. The method of claim 3, wherein the UE transmits the location and the location uncertainty to discover nearby devices that have a common interest in supporting proximity services that are related to the UE and the nearby devices being near to each another.

6. The method of claim 5, wherein the proximity services comprise services that notify a user when friends, relatives, or co-workers are nearby or notify a user when the user is near to a place of interest.

7. The method of claim 1, wherein the first location and the first location uncertainty of the first device are received by the UE using direct peer-to-peer radio communications.

8. The method of claim 1, further comprising:
tracking the location of the UE using inertial navigation after entering the poor positioning environment.

9. The method of claim 1, wherein the UE receives the first location and the first location uncertainty after entering the poor positioning environment.

10. The method of claim 1, wherein the poor positioning environment is an environment in which the UE is unable to determine the location of the UE using a satellite, cellular, and/or local wireless network positioning system.

11. The method of claim 1, wherein the first device is located within the poor positioning environment.

12. The method of claim 11, wherein the first device transmits the first location and the first location uncertainty in response to detecting the poor positioning environment.

13. The method of claim 1, wherein the first device determines an initial location based on a near-field communication (NFC) or Bluetooth (BT) device and/or a satellite, cellular, and/or local wireless network positioning system before determining the first location while inside the poor positioning environment.

14. The method of claim 1, wherein the UE determines a location of the UE based on a satellite, cellular, and/or local wireless network positioning system before entering the poor positioning environment.

15. The method of claim 1, wherein the UE determines a location of the UE based on one or more NFC or BT devices upon entering the poor positioning environment.

16. The method of claim 1, wherein the first location uncertainty is less than the location uncertainty of the UE if the first device has been in the poor positioning environment a shorter period of time than the UE.

17. The method of claim 1, wherein the first location uncertainty is less than the location uncertainty of the UE if the first device has travelled a shorter distance within the poor positioning environment than the UE.

18. The method of claim 1, further comprising:
determining the distance to the first device; and
if the distance is less than a threshold, setting the distance to the first device to zero and adopting the first location as the location of the UE.

19. The method of claim 18, wherein the UE sets the distance to zero and adopts the first location as the location of the UE if the signal strength of a signal received from the first device is above a threshold.

20. The method of claim 1, wherein the location uncertainty of the UE is based on an elapsed amount of time since the UE entered the poor positioning environment.

21. The method of claim 20, wherein the location uncertainty increases as the elapsed amount of time increases.

22. The method of claim 1, wherein the location uncertainty of the UE is based on an estimated distance travelled since the UE entered the poor positioning environment.

23. The method of claim 22, wherein the location uncertainty increases as the estimated distance travelled increases.

24. The method of claim 1, further comprising:
receiving location information and location uncertainties from a plurality of devices including the first device;
determining which of the location uncertainties are less than the location uncertainty of the UE; and
determining the location of the UE based on locations of each of the plurality of devices having a location uncertainty less than the location uncertainty of the UE.

25. The method of claim 1, further comprising:
storing a history of determined locations, received locations, and location uncertainty levels; and
transmitting the history to a server.

26. The method of claim 25, wherein the server uses the history to verify a location of one or more terrestrial access points based on which the UE or the first device determined a location prior to entering the poor positioning environment.

27. An apparatus for determining a location of a user equipment (UE) in a poor positioning environment based on locations of one or more devices, comprising:
logic configured to receive, from a first device, a first location and a first location uncertainty of the first device;
logic configured to determine whether or not the first location uncertainty is less than a location uncertainty of the UE; and
logic configured to determine the location of the UE based on the location of the first device and a distance to the first device if the first location uncertainty is less than the location uncertainty of the UE.

28. The apparatus of claim 27, wherein the first location and the first location uncertainty of the first device are received by the UE using direct peer-to-peer radio communications.

29. The apparatus of claim 27, wherein the first location uncertainty is less than the location uncertainty of the UE if the first device has been in the poor positioning environment a shorter period of time than the UE.

30. The apparatus of claim 27, wherein the first location uncertainty is less than the location uncertainty of the UE if the first device has travelled a shorter distance within the poor positioning environment than the UE.

31. The apparatus of claim 27, further comprising:
logic configured to determine the distance to the first device; and
logic configured to set the distance to the first device to zero and adopting the first location as the location of the UE if the distance is less than a threshold.

32. The apparatus of claim 27, further comprising:
logic configured to receive location information and location uncertainties from a plurality of devices including the first device;
logic configured to determine which of the location uncertainties are less than the location uncertainty of the UE; and
logic configured to determine the location of the UE based on locations of each of the plurality of devices having a location uncertainty less than the location uncertainty of the UE.

33. The apparatus of claim 27, further comprising:
logic configured to store a history of determined locations, received locations, and location uncertainty levels; and
logic configured to transmit the history to a server.

34. An apparatus for determining a location of a user equipment (UE) in a poor positioning environment based on locations of one or more devices, comprising:
means for receiving, from a first device, a first location and a first location uncertainty of the first device;
means for determining whether or not the first location uncertainty is less than a location uncertainty of the UE; and
means for determining the location of the UE based on the location of the first device and a distance to the first device if the first location uncertainty is less than the location uncertainty of the UE.

35. The apparatus of claim 34, wherein the first location and the first location uncertainty of the first device are received by the UE using direct peer-to-peer radio communications.

36. The apparatus of claim 34, wherein the first location uncertainty is less than the location uncertainty of the UE if the first device has been in the poor positioning environment a shorter period of time than the UE.

37. The apparatus of claim 34, wherein the first location uncertainty is less than the location uncertainty of the UE if the first device has travelled a shorter distance within the poor positioning environment than the UE.

38. The apparatus of claim 34, further comprising:
means for determining the distance to the first device; and
means for setting the distance to the first device to zero and adopting the first location as the location of the UE if the distance is less than a threshold.

39. The apparatus of claim 34, further comprising:
means for receiving location information and location uncertainties from a plurality of devices including the first device;
means for determining which of the location uncertainties are less than the location uncertainty of the UE; and
means for determining the location of the UE based on locations of each of the plurality of devices having a location uncertainty less than the location uncertainty of the UE.

40. The apparatus of claim 34, further comprising:
means for storing a history of determined locations, received locations, and location uncertainty levels; and
means for transmitting the history to a server.

41. A non-transitory computer-readable medium for determining a location of a user equipment (UE) in a poor positioning environment based on locations of one or more devices, comprising:
at least one instruction to receive, from a first device, a first location and a first location uncertainty of the first device;
at least one instruction to determine whether or not the first location uncertainty is less than a location uncertainty of the UE; and
at least one instruction to determine the location of the UE based on the location of the first device and a distance to the first device if the first location uncertainty is less than the location uncertainty of the UE.

42. The non-transitory computer-readable medium of claim 41, wherein the first location and the first location uncertainty of the first device are received by the UE using direct peer-to-peer radio communications.

43. The non-transitory computer-readable medium of claim 41, wherein the first location uncertainty is less than the location uncertainty of the UE if the first device has been in the poor positioning environment a shorter period of time than the UE.

44. The non-transitory computer-readable medium of claim 41, wherein the first location uncertainty is less than the location uncertainty of the UE if the first device has travelled a shorter distance within the poor positioning environment than the UE.

45. The non-transitory computer-readable medium of claim 41, further comprising:
at least one instruction to determine the distance to the first device; and
at least one instruction to set the distance to the first device to zero and adopting the first location as the location of the UE if the distance is less than a threshold.

46. The non-transitory computer-readable medium of claim 41, further comprising:
at least one instruction to receive location information and location uncertainties from a plurality of devices including the first device;
at least one instruction to determine which of the location uncertainties are less than the location uncertainty of the UE; and
at least one instruction to determine the location of the UE based on locations of each of the plurality of devices having a location uncertainty less than the location uncertainty of the UE.

47. The non-transitory computer-readable medium of claim 41, further comprising:
at least one instruction to store a history of determined locations, received locations, and location uncertainty levels; and
at least one instruction to transmit the history to a server.
